(19) United States
(12) Patent Application Publication
(10) Pub. No.: US 2025/0213893 A1
(43) Pub. Date: Jul. 3, 2025

(54) FACE SHIELD HEADS UP DISPLAY WITH RESCUE GUIDANCE

(71) Applicant: Gentex Corporation, Zeeland, MI (US)

(72) Inventor: David J. Wright, Grand Rapids, MI (US)

(21) Appl. No.: 19/001,747

(22) Filed: Dec. 26, 2024

Related U.S. Application Data
(60) Provisional application No. 63/615,473, filed on Dec. 28, 2023.

(51) Int. Cl. A62B 9/00; A62B 18/08; G01C 21/20; G06T 7/70; G09G 3/00; H04N 23/23

(52) U.S. Cl. CPC A62B 9/006; A62B 18/08; G01C 21/20; G06T 7/70; G09G 3/001; H04N 23/23; G06T 2207/10048; G06T 2207/30196

(57) ABSTRACT

A rescue guidance system includes a thermal imager mountable on a self-contained breathing apparatus pack and capturing thermal image data of an area at least partially surrounded by a wearer including and a display unit configured for mounting within a face shield associated with the self-contained breathing apparatus in a field of view of the wearer. The display unit has a plurality of LED light elements configured as directional indicators relative to the wearer. A controller receives the image data and determines a location of a person within the thermal image data and correlates the location of the person within the thermal image data to an approximate location of the person relative to the wearer and illuminates a selected one of the plurality of directional indicators approximately corresponding with a direction of the location of the person relative the wearer.

### CROSS-REFERENCE TO RELATED APPLICATION

This application claims priority to and the benefit under 35 U.S.C. § 119(e) of U.S. Provisional Application No. 63/615,473, filed on Dec. 28, 2023, entitled “FACE SHIELD HEADS UP DISPLAY WITH RESCUE GUIDANCE,” the disclosure of which is hereby incorporated herein by reference in its entirety.

### BACKGROUND

The present disclosure relates generally to a rescue guidance system and more particularly, relates to a system incorporating a heads-up display in a firefighter face shield.

Thermal imagers can be used in rescue situations, including those with low visibility, such as during a fire or other settings with heavy smoke or the like. Thermal imagers are generally configured as a device that creates an image using infrared (“IR”) radiation, as recorded by a specialized imaging sensor that is sensitive to electromagnetic radiation at wavelengths from about 1000 nm to about 14000 nm. They may also be referred to as thermographic cameras or imagers, thermal imaging cameras, or infrared cameras. These types of imagers may be advantageous for rescue operations, including by firefighters or other emergency response personnel working in and around fires, due to their ability to operate without ambient light and to detect the thermal profile of a person through smoke. Typically, thermal imagers are associated with a device that includes a screen or other means for displaying the thermal image directly, such as by translating the image to a corresponding visible spectrum for display. In various examples, these devices can be handheld or can have a screen incorporated in or on a mask associated with an SCBA device. Such devices, however, either obstruct a wearer's field of view or require the user to view the image on the device, thus diverting their attention from their actual surroundings. Notably, while a thermal image may help a user identify people to be rescued or other attention during a fire, the thermal image will not help them visualize objects that are the same temperature as the other surroundings.

### SUMMARY

According to one aspect of the disclosure, a rescue guidance system includes a thermal imager mountable on a self-contained breathing apparatus pack and capturing thermal image data of an area at least partially surrounded by a wearer including and a display unit configured for mounting within a face shield associated with the self-contained breathing apparatus in a field of view of the wearer. The display unit has a plurality of light-emitting diode (“LED”) light elements configured as directional indicators relative to the wearer. A controller receives the image data and determines a location of a person within the thermal image data and correlates the location of the person within the thermal image data to an approximate location of the person relative to the wearer and illuminates a selected one of the plurality of directional indicators approximately corresponding with a direction of the location of the person relative the wearer.

According to another aspect of the disclosure, a self-contained breathing apparatus includes a mask including a face shield positionable over at least the eyes of a wearer, a pack configured for mounting an air tank to the body of the wearer, and a rescue guidance system. The rescue guidance system includes a thermal imager mountable on the harness and capturing thermal image data of an area at least partially surrounded by the wearer and a display unit configured for mounting within the mask adjacent the face shield. The display unit includes a plurality of LED light elements configured as directional indicators relative to the wearer. The rescue guidance system further includes a controller receiving the image data and determining a location of a person within the thermal image data and correlating the location of the person within the thermal image data to an approximate location of the person relative to the wearer and illuminating a selected one of the plurality of directional indicators approximately corresponding with a direction of the location of the person relative the wearer.

According to another aspect of the disclosure, a mask useable in a self contained breathing apparatus system includes a face shield positionable over at least the eyes of a wearer, a respirator unit positioned below the face shield and connectable with an air tank, and a display unit configured for mounting within the mask adjacent the face shield. The display unit has a plurality of LED light elements configured as directional indicators relative to the wearer.

These and other features, advantages, and objects of the present device will be further understood and appreciated by those skilled in the art upon studying the following specification, claims, and appended drawings.

### BRIEF DESCRIPTION OF THE DRAWINGS

The present invention will become more fully understood from the detailed description and the accompanying drawings, wherein:

FIG. 1 is a diagram of a rescue system included in a self-contained breathing apparatus according to an aspect of the disclosure;

FIG. 2 is a schematic diagram of the system according to the disclosure;

FIG. 3 is an interior view of a mask associated with the self-contained breathing apparatus and incorporating aspects of the present system;

FIG. 4A is a schematic view of a wearer of the system in a use context;

FIG. 4B is a depiction of a directional display according to the context of FIG. 4A according to an aspect of the system;

FIG. 4C is a representation of image data obtained by an imager of the system in the use context of FIG. 4A;

FIG. 5A is a schematic view of a wearer of the system in a further use context;

FIG. 5B is a depiction of the directional display according to the context of FIG. 5A according to a further aspect of the system;

FIG. 5C is a representation of image data obtained by an imager of the system in the use context of FIG. 5A; and

FIG. 6 is an interior view of a mask associated with the self-contained breathing apparatus and incorporating aspects of an alternative system according to a further aspect of the disclosure.

### DETAILED DESCRIPTION OF EMBODIMENTS

The present illustrated embodiments reside primarily in combinations of method steps and apparatus components related to a rescue system. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

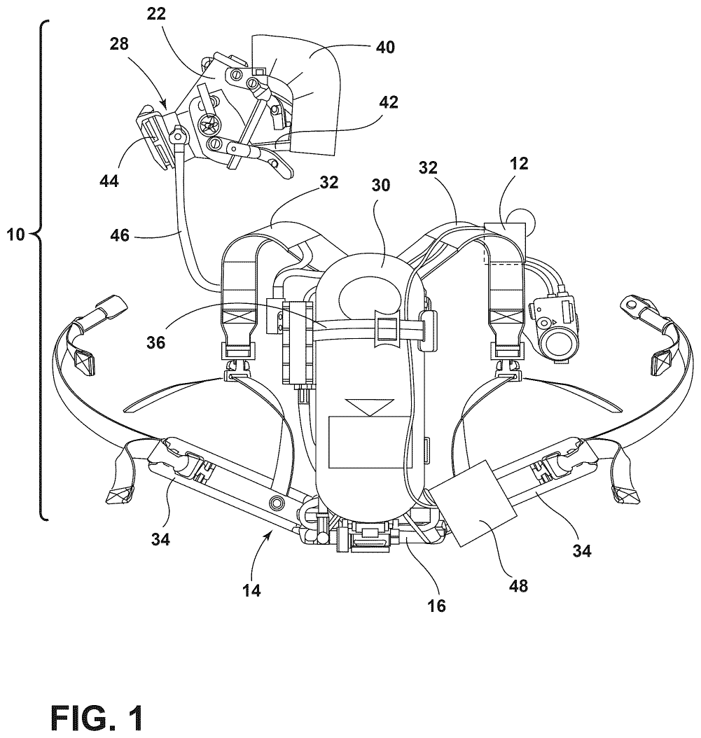

For purposes of description herein the terms “upper,” “lower,” “right,” “left,” “rear,” “front,” “vertical,” “horizontal,” and derivatives thereof shall relate to the device as oriented in FIG. 1. However, it is to be understood that the device may assume various alternative orientations and step sequences, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Ordinal modifiers (i.e., “first”, “second”, etc.) may be used to distinguish between various structures of the disclosed rescue system in various contexts, but that such ordinals are not necessarily intended to apply to such elements outside of the particular context in which they are used and that, in various aspects different ones of the same class of elements may be identified with the same, context-specific ordinal. In such instances, other particular designations of the elements are used to clarify the overall relationship between such elements. Ordinals are not used to designate a position of the elements, nor do they exclude additional, or intervening, non-ordered elements or signify an importance or rank of the elements within a particular class.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . . ” does not, without more constraints, preclude the existence of additional identical elements in the process, method, article, or apparatus that comprises the element.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

For purposes of this disclosure, the terms “about”, “approximately”, or “substantially” are intended to mean that a value of a parameter is close to a stated value or position. However, minor differences may prevent the values or positions from being exactly as stated. Thus, unless otherwise noted, differences of up to ten percent (10%) for a given value are reasonable differences from the ideal goal of exactly as described. In many instances, a significant difference can be when the difference is greater than ten percent (10%), except as where would be generally understood otherwise by a person of ordinary skill in the art based on the context in which such term is used.

Referring to FIGS. 1-3, reference numeral 10 generally designates a rescue guidance system. Rescue guidance system 10 includes a thermal imager 12 mountable on a wearer W of a self-contained breathing apparatus (“SCBA”) 14 pack 16 and capturing thermal image data 18 of an area A at least partially surrounding the wearer W and a display unit 20 configured for mounting within a face shield 22 associated with the SCBA 14 in a field of view of the wearer W. The display unit 20 has a plurality of LED light elements 24 configured as directional indicators relative to the wearer W. A controller 26 receives the image data 18 and determines a location L of a person P within the thermal image data 18 and correlates the location L of the person P within the thermal image data 18 to an approximate location L′ of the person P relative to the wearer W and illuminates a selected one of the plurality of directional indicators 24 approximately corresponding with a direction D of the location L′ of the person relative the wearer W.

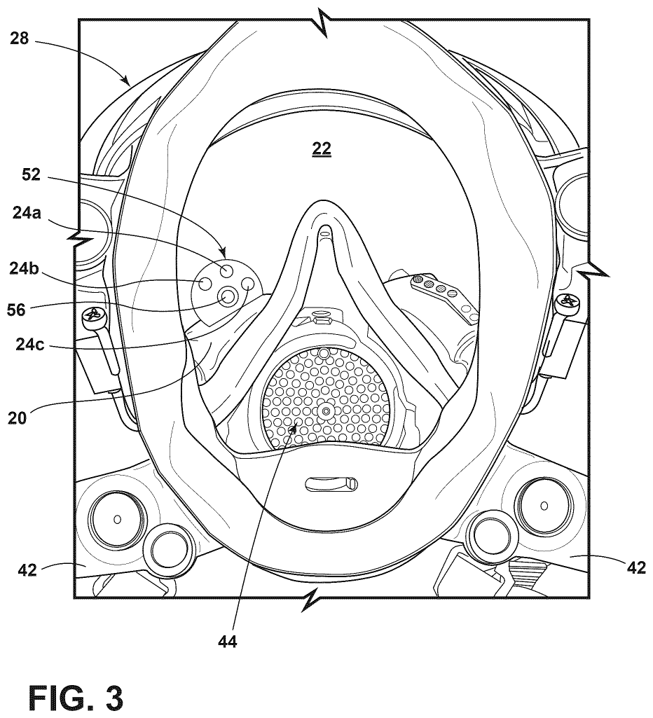

Referring specifically to FIG. 1, an example of an SCBA 14 is shown and includes the aforementioned pack 16 and a mask 28 that includes the face shield 22. The pack 16 is primarily configured to secure a tank 30 to the back of the wearer W by way of shoulder straps 32 and a belt 34 that attach to a tank holder 36, although it is appreciated that other arrangements for the pack 16 are possible. The tank 30 is fillable with compressed air or a mixture of atmospheric gasses containing oxygen so as to be breathable by the wearer to support respiration. In this manner, the face shield 22 is configured as a component of the mask 28 that is configured to sealingly fit over the face of the wearer, including by way of an included hood 40 and/or straps 42 according to various known arrangements. The mask 28 includes a respirator unit 44 that connects with the tank 30 by way of a hose 46 to supply a breathable gas mixture containing an acceptable level of oxygen with the mask 28 further being configured to vent exhaled respiratory gas. As shown in FIGS. 1 and 3, the face shield 22 is a transparent insert secured within the mask 28 to provide a viewing area for the wearer while enclosing the ambient environment around the face for breathing and protection.

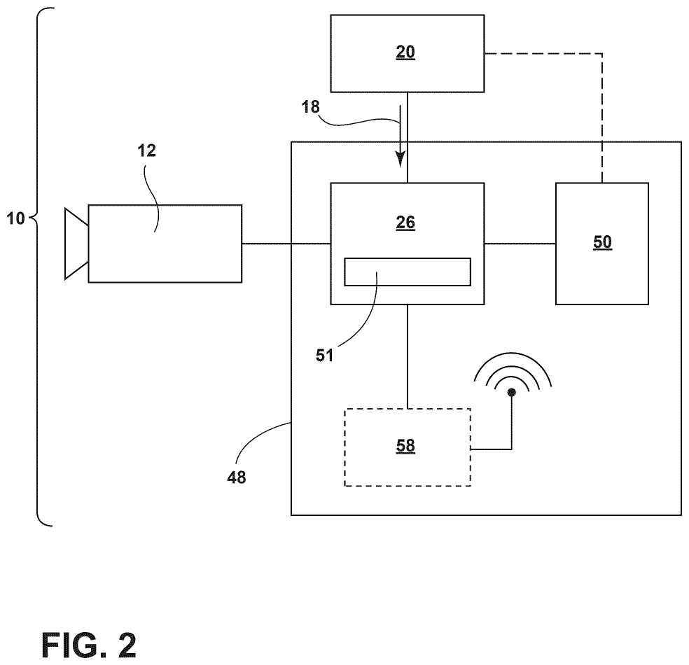

As shown in FIGS. 1 and 2, the above-mentioned thermal imager 12 can be mounted to the wearer by being mounted on the pack 16 and, in the illustrated example, to one of the shoulder straps 32, such as the same one of the shoulder straps 32 to which an operator unit 48 for a regulator 44 associated with the tank 30 and hose 46. In other examples, the thermal imager 12 can be mounted with the opposite shoulder strap 32, to a portion of the mask 28, or the hood 40, although mounting to the pack 16 may be preferred for weight considerations and/or balancing of the mask 28. The thermal imager 12 is generally configured as a device that creates an image using infrared (“IR”) radiation, as recorded by a specialized imaging sensor that is sensitive to electromagnetic radiation at wavelengths from about 1000 nm to about 14000 nm and may also be referred to as a thermographic camera or imager, a thermal imaging camera, or an infrared camera. Such an imager may be advantageous for rescue operations, including by firefighters or other emergency response personnel working in and around fires, due to their ability to operate without ambient light and to detect the thermal profile of a person through smoke. Typically, thermal imagers are associated with a device that includes a screen or other means for displaying the thermal image directly, such as by translating the image to a corresponding visible spectrum for display. In various examples, these devices can be handheld or can have a screen incorporated in or on a mask associated with an SCBA device. Such devices, however, either obstruct a wearer's field of view or require the user to view the image on the device, thus diverting their attention from their actual surroundings. Notably, while a thermal image may help a user identify people to be rescued or other attention during a fire, the thermal image will not help them visualize objects that are the same temperature as the other surroundings.

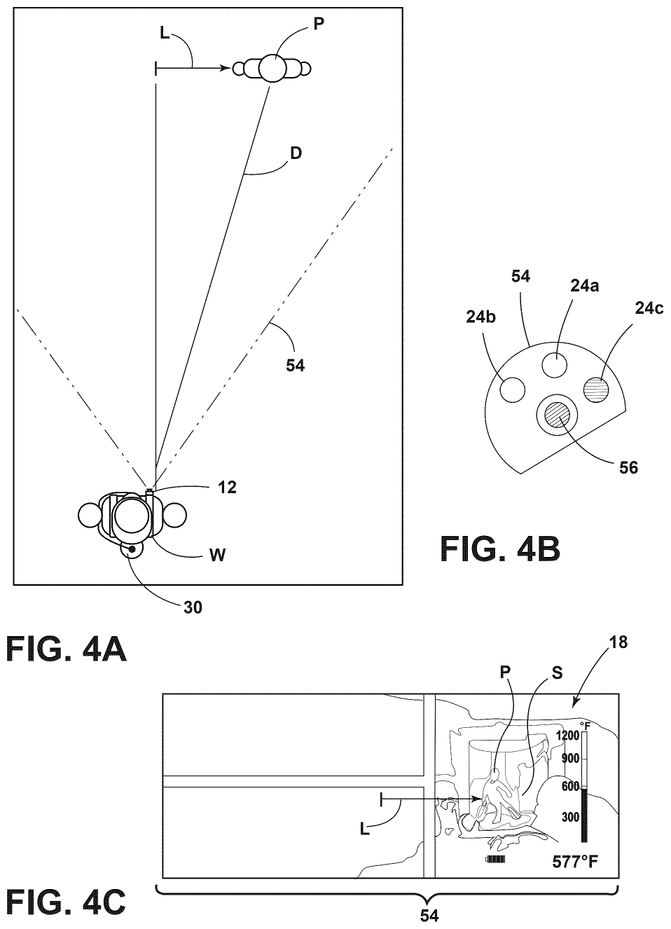

Continuing with respect to FIGS. 1-3, the present system 10 includes a control unit 48 with which the imager 12 is communicatively coupled (e.g., through a wire). The control unit 48 can include the above-referenced controller 26 along with a power source 50 (e.g., one or more batteries and/or a battery pack) and may be mounted separately from the imager 12, such as on the belt 34, as shown in FIG. 3, or incorporated with the imager 12 in a single unit. As mentioned above, the controller can be configured to detect a person P (FIGS. 4A and 4C, for example) within the thermal image data. This detection can be made by programming or otherwise configuring the controller 26, including by providing such programming in memory 51 in or operably accessible by the controller 26, to recognize portions of the image data that correspond in general size, shape, temperature, or various combinations thereof, to a person. Various forms algorithms for such visual detection, including those adapted or adaptable for use with thermal imaging data, including various forms or combinations of edge detection, object recognition, and machine learning, can be used for such detection. The controller 26 can then correlate the location of a detected person P within the thermal image data 18 (i.e., which corresponds with a vertical plane extending vertically and horizontally in front of the wearer) with a location of the person P with respect to the wearer W (i.e., along a horizontal plane generally corresponding with the ground on which the wearer W is standing. This correlation can include a lateral distance component L and, optionally, an approximate distance D (e.g., based on the size of the detected person P within the image data 18).

As shown in FIG. 3, the display unit 20 included with system 10 can be incorporated into the mask 28, including by addition to display units similar to those that may already be used to communicate other data, including the tank level or the like, to the wearer W. In the example shown, the display unit 20 includes a directional display 52 that incorporates the above-mentioned directional indicators (LED light sources) 24. In the illustrated example, the directional indicators 24 are arranged to generally correspond with directions relative to the wearer's field of view, including one directional indicator 24a corresponding with a forward direction relative to the wearer W, one directional indicator 24b corresponding with a direction to the left of the wearer W, and one directional indicator 24c corresponding with a direction to the right of the wearer W. In such an example, the directional indicators 24 can all be directed somewhat forward of the wearer W to correspond with the field of view 54 of the imager 12, which may cover only a portion of the area around the wearer W that is generally forward of the wearer W (i.e., in the direction in which the imager 12 is directed). In connection with this example, the controller 26 can evaluate the lateral direction component D associated with the position of the detected person P relative to the center of the field of view 54 and select the directional indicator 24a, 24b, or 24c that best corresponds with the location of the detected person P based on the lateral direction component D. In one example, a person P detected within the middle 30% of the field of view 54 can be indicated with the center directional indicator 24a, while a person P detected in the left and right 35% of the field of view 54 can be represented using the left and right directional indicators 24b and 24c, respectively.

As further shown in FIG. 3, the directional display 52 can be positioned so as to be readily viewable by the wearer W, such as by being positioned so as to overlap a lower portion of the face shield 22. In this manner, the user can see the display 52 without having their view substantially obstructed by the directional display 52. In one aspect, the directional indicators 24 can be spaced such that the user can obtain a visual sense of a detected person P and their relative location without focusing on the directional display 52. In a further aspect, the display unit can further include an additional LED light element configured as a detection indicator 56. In this aspect, the controller 26 can be further configured to illuminate the detection indicator 56 responsive to detecting a person P within the thermal image data. In one aspect, the controller can be configured to illuminate the detection indicator 56 at a lower detection threshold than the directional indicators 24, including when a specific determination as to the lateral directional component L cannot be made. In a further aspect, the detection indicator 56 can be illuminated in a flashing pattern to indicate a number of detected people P within the image data 18 so as not to confuse the wearer W if multiple directional indicators 24 are illuminated at the same time. In a still further aspect, the controller 26 can be further configured to illuminate either detection indicator 56 or the selected one of the direction indicators 24a, 24b, or 24c (i.e., corresponding with the lateral directional component L of the detected person P or persons P) according to a pattern of activations and deactivations approximately indicating a distance of the location of the person P relative to the wearer. This distance indication can be used in connection with the above-described implementation of the controller 26 that is configured to determine or otherwise estimate the distance D to the detected person P. In one example, the controller 26 can illuminate the detection indicator 56 in a flashing pattern to indicate the number of people detected P, while illuminating the directional indicators 24a, 24b, 24c corresponding with the lateral directional component L and corresponding position of the detected person P or persons P in a flashing pattern to indicate the respective distance or distances of the closes person P detected in the corresponding area of the field of view 54. The flashing pattern of the directional indicators 24 can indicated distance, for example, by way of a scheme where slower flashing (or a greater interval between illuminations) corresponds with a greater distance D and the interval between illuminations decreases with decreasing distance D.

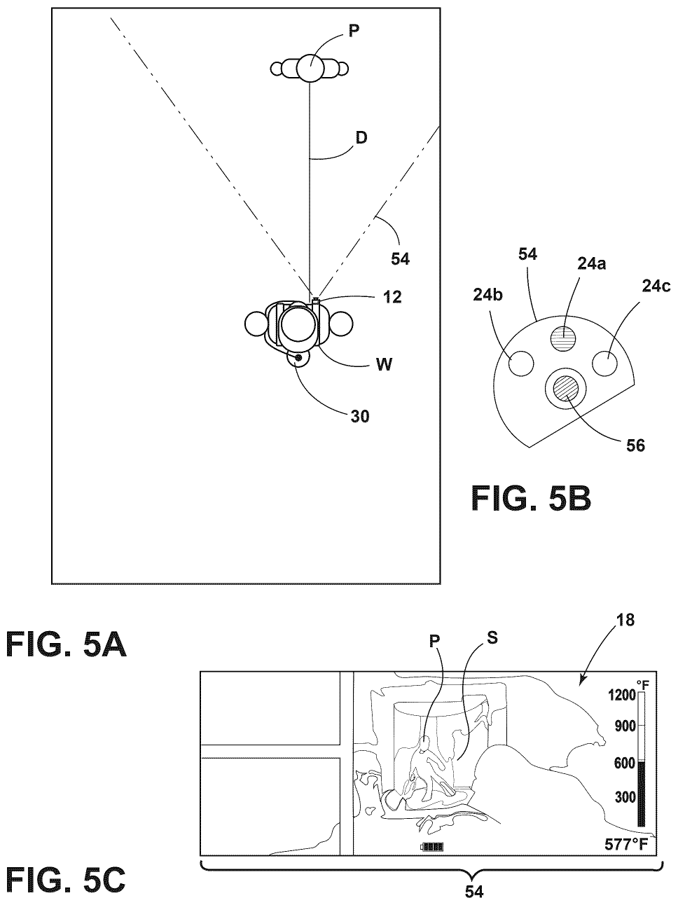

FIGS. 4A to 5C show an example of the use of the directional display 52 for indicating the detection and position of a person P. As shown in FIG. 4A, a person P is present within the field of view 54 of the imager 12. A graphic representation of the image data 18 is shown in FIG. 4C (with it being noted that the image data 18 is representative and not actually displayed by system 10). In the present example, the position of the person P includes a lateral directional component L toward the outer third of the field of view 54 on the right side thereof. Accordingly, the controller 26 can cause the detection indicator 56 to be illuminated according to a selected illumination pattern and the right direction indicator 24c to also be illuminated. As discussed above, the controller 26 may be configured to correlate a size S of the person P within the image data 18 to an estimated distance D (FIG. 4A) being indicated using, for example, direction indicator 24c, as discussed above. As shown in FIG. 5A, the wearer W, in response to the detection information communicated in FIG. 4B has moved to a position closer to, and more directly aligned with person P. In response to this positioning, the controller 26 illuminates the center directional indicator 24a, as shown in FIG. 5C. Additionally, the controller 26 can change the illumination pattern associated with directional indicator 24a to correspond with the closer distance D, according to the selected scheme and as discussed above.

In a further aspect, system 10 can include a communication module 58 (FIG. 2) communicatively coupled with the controller 26, such as by being included within the control unit 48. The communication module 58 can be configured to communicate with an external communication module associated with another wearer, such as in an additional implementation of system 10 worn by the other wearer, with such wearers being members of the same rescue unit or team. In this manner, the controller 26 can be further configured to determine a location of the other wearer relative to the wearer of the subject system 10 and to cause illumination of a selected one of the directional indicators 24 approximately corresponding with the location of the other wearer relative to the subject wearer. This communication can be mutual, such that the other implementation of the system 10 can receive similar information and make a corresponding indication. In connection with this variation of system 10, the directional display 52 can include additional directional indicators 24 to accommodate the display of additional detections (which can be represented by a different illumination color, for example) and/or to indicate the position of the other wearer when behind the subject wearer W.

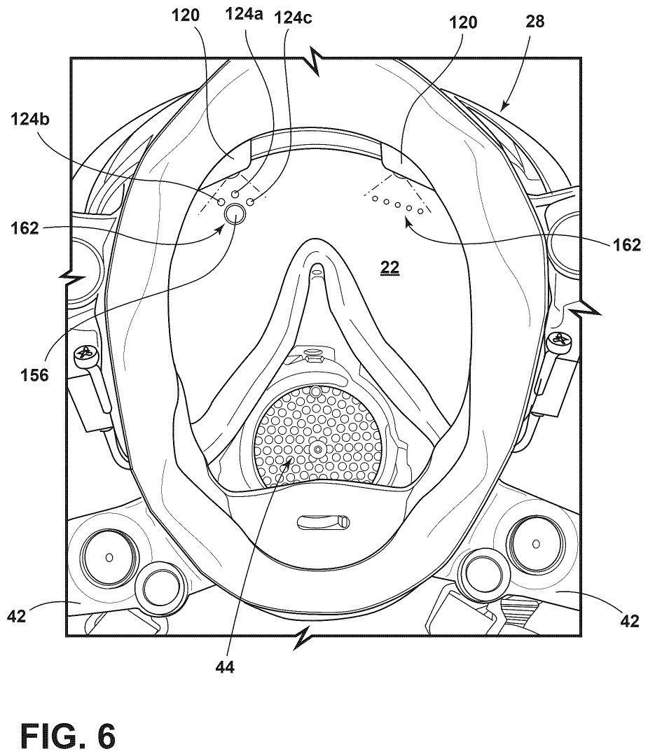

Turning to FIG. 6, in a variation of system 10, the display unit 120 can be configured as or otherwise incorporated in a projector that can be positioned substantially out of the view of the wearer W. In this manner, the display unit 120 can project an image 162 onto the interior of the face shield 22, with the image 160 including at least an illuminated one of the plurality of LED light elements, including the directional indicators 124a, 124b, and 124c, and, optionally, the detection indicator 156. As shown, the display unit 120 can be configured to project the image 160 onto the face shield 22 in a location visible to the wearer. The generally transparent nature of this type of display can allow for positioning of the image 160 in an area more closely aligned with the wearer's primary line of sight, as an obstruction is reduced. Additionally, the display unit 120 can be configured to project an additional image 162 to replace the tank level indication of a known LED display unit, as shown in FIG. 3.

The invention disclosed herein is further summarized in the following paragraphs and is further characterized by combinations of any and all of the various aspects described therein.

According to another aspect of the present disclosure, a rescue guidance system includes a thermal imager mountable on a self-contained breathing apparatus pack and capturing thermal image data of an area at least partially surrounded by a wearer including and a display unit configured for mounting within a face shield associated with the self-contained breathing apparatus in a field of view of the wearer. The display unit has a plurality of LED light elements configured as directional indicators relative to the wearer. A controller receives the image data and determines a location of a person within the thermal image data and correlates the location of the person within the thermal image data to an approximate location of the person relative to the wearer and illuminates a selected one of the plurality of directional indicators approximately corresponding with a direction of the location of the person relative the wearer.

In the rescue guidance system of ¶[0031], the display unit can further include an LED light element configured as a detection indicator, and the controller can be further configured to determine the presence of a person within the thermal image data and to illuminate the detection indicator responsive to detecting a person within the thermal image data.

In the rescue guidance system of either ¶¶[0031] or [0032], the controller can be further configured to illuminate one of the selected one of the direction indicators and the detection indicator according to a pattern of activations and deactivations approximately indicating a distance of the location of the person relative to the wearer.

The rescue guidance system of any of ¶¶[0031]-[0033] can further include a communication module coupled with the controller and configured to communicate with an external communication module associated with another wearer, and the controller is further configured to determine a location of the another wearer relative to the wearer and to cause illumination of a selected one of the directional indicators approximately corresponding with the location of the another wearer relative to the wearer.

In the rescue guidance system of any of ¶¶[0031]-[0034], the display can be a projector configured to project an image including at least an illuminated one of the plurality of LED light elements onto the face shield in a location visible to the wearer.

It will be understood by one having ordinary skill in the art that construction of the described disclosure and other components is not limited to any specific material. Other exemplary embodiments of the disclosure disclosed herein may be formed from a wide variety of materials, unless described otherwise herein.

It is also important to note that the construction and arrangement of the elements of the disclosure as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

The above description is considered that of the preferred embodiments only. Modifications of the invention will occur to those skilled in the art and to those who make or use the invention. Therefore, it is understood that the embodiments shown in the drawings and described above are merely for illustrative purposes and not intended to limit the scope of the invention, which is defined by the claims as interpreted according to the principles of patent law, including the doctrine of equivalents.

What is claimed is:

1. A rescue guidance system, comprising:
a thermal imager mountable on a wearer of a self-contained breathing apparatus pack and capturing thermal image data of an area at least partially surrounded by the wearer including;
a display unit configured for mounting within a face shield associated with the self-contained breathing apparatus in a field of view of the wearer, the display unit including a plurality of LED light elements configured as directional indicators relative to the wearer; and
a controller receiving the image data and determining a location of a person within the thermal image data and correlating the location of the person within the thermal image data to an approximate location of the person relative to the wearer and illuminating a selected one of the plurality of directional indicators approximately corresponding with a direction of the location of the person relative the wearer.

2. The rescue guidance system of claim 1, wherein the plurality of LED light elements are configured as the directional indicators by being arranged in an array with respective ones of the LED light elements corresponding to respective directions relative to the wearer.

3. The rescue guidance system of claim 1, wherein the controller is further configured to illuminate the selected one of the direction indicators according to a pattern of activations and deactivations approximately indicating a distance of the person relative to the wearer.

4. The rescue guidance system of claim 1, wherein:
the display unit further includes an LED light element configured as a detection indicator; and
the controller is further configured to determine a presence of a person within the thermal image data and to illuminate the detection indicator responsive to detecting a person within the thermal image data.

5. The rescue guidance system of claim 4, wherein the controller is further configured to:
detect multiple people within the thermal image data;
determine a number of the multiple people within the thermal image data; and
illuminate the detection indicator according to a pattern of activations and deactivations indicating the number of the multiple people detected within the thermal image data.

6. The rescue guidance system of claim 1, further including a communication module coupled with the controller and configured to communicate with an external communication module associated with another wearer, wherein:
the controller is further configured to determine a location of the another wearer relative to the wearer and to cause illumination of a selected one of the directional indicators approximately corresponding with the location of the another wearer relative to the wearer.

7. The rescue guidance system of claim 1, wherein the display unit is mounted in a housing configured to fit along a lower edge of the face shield adjacent a portion of a respirator unit of a mask that includes the face shield and the respirator with the respirator positioned below the face shield.

8. The rescue guidance system of claim 1, wherein the display unit is a projector configured to project an image including at least an illuminated one of the plurality of LED light elements onto the face shield in a location visible to the wearer.

9. A self-contained breathing apparatus, comprising:
a mask including a face shield positionable over at least the eyes of a wearer;
a pack configured for mounting an air tank to the body of the wearer; and
a rescue guidance system, including:
a thermal imager mountable on the harness and capturing thermal image data of an area at least partially surrounded by the wearer;
a display unit configured for mounting within the mask adjacent the face shield, the display unit including a plurality of LED light elements configured as directional indicators relative to the wearer; and
a controller receiving the image data and determining a location of a person within the thermal image data and correlating the location of the person within the thermal image data to an approximate location of the person relative to the wearer and illuminating a selected one of the plurality of directional indicators approximately corresponding with a direction of the location of the person relative the wearer.

10. The self-contained breathing apparatus of claim 9, wherein the plurality of LED light elements are configured as the directional indicators by being arranged in an array with respective ones of the LED light elements corresponding to respective directions relative to the wearer.

11. The self-contained breathing apparatus of claim 9, wherein the controller is further configured to illuminate the selected one of the direction indicators according to a pattern of activations and deactivations approximately indicating a distance of the person relative to the wearer.

12. The self-contained breathing apparatus of claim 9, wherein:
the display unit further includes an LED light element configured as a detection indicator; and
the controller is further configured to determine a presence of a person within the thermal image data and to illuminate the detection indicator responsive to detecting a person within the thermal image data.

13. The self-contained breathing apparatus of claim 12, wherein the controller is further configured to:
detect multiple people within the thermal image data;
determine a number of the multiple people within the thermal image data; and
illuminate the detection indicator according to a pattern of activations and deactivations indicating the number of the multiple people detected within the thermal image data.

14. The self-contained breathing apparatus of claim 9, further including a communication module coupled with the controller and configured to communicate with an external communication module associated with another wearer, wherein:
the controller is further configured to determine a location of the another wearer relative to the wearer and to cause illumination of a selected one of the directional indicators approximately corresponding with the location of the another wearer relative to the wearer.

15. The self-contained breathing apparatus of claim 9, wherein the display unit is mounted in a housing configured to fit along a lower edge of the face shield in a field of view of the wearer and adjacent a portion of a respirator unit of the mask positioned below the face shield.

16. The self-contained breathing apparatus of claim 9, wherein the display unit is a projector configured to project an image including at least an illuminated one of the plurality of LED light elements onto the face shield in a location visible to the wearer.

17. A mask useable in a self contained breathing apparatus system, comprising:
a face shield positionable over at least the eyes of a wearer;
a respirator unit positioned below the face shield and connectable with an air tank; and
a display unit configured for mounting within the mask adjacent the face shield, the display unit including a plurality of LED light elements configured as directional indicators relative to the wearer.

18. The mask of claim 17, wherein the display unit is mounted in a housing configured to fit along a lower edge of the face shield adjacent a portion of a respirator unit in a field of view of the wearer.

19. The mask of claim 17, wherein the display unit is a projector configured to project an image including at least an illuminated one of the plurality of LED light elements onto the face shield in a location visible to the wearer.

20. The mask of claim 17, wherein the display unit is usable in a rescue guidance system further including:
a thermal imager capturing thermal image data of an area at least partially surrounded by the wearer including; and
a controller connected with the thermal imager and the display unit, receiving the image data and determining a location of a person within the thermal image data, correlating the location of the person within the thermal image data to an approximate location of the person relative to the wearer, and illuminating a selected one of the plurality of directional indicators approximately corresponding with a direction of the location of the person relative the wearer.
